(19) United States
(12) Patent Application Publication
(10) Pub. No.: US 2018/0123898 A1
(43) Pub. Date: May 3, 2018

(54) NETWORK VERIFICATION DEVICE, NETWORK VERIFICATION METHOD AND PROGRAM RECORDING MEDIUM

(71) Applicant: NEC Corporation, Minato-ku, Tokyo (JP)

(72) Inventors: Yutaka YAKUWA, Tokyo (JP); Toshio TONOUCHI, Tokyo (JP); Satoshi YAMAZAKI, Tokyo (JP)

(73) Assignee: NEC Corporation, Minato-ku, Tokyo (JP)

(21) Appl. No.: 15/573,559

(22) PCT Filed: Jun. 7, 2016
(86) PCT No.: PCT/JP2016/002753

§ 371 Date: Nov. 13, 2017

(30) Foreign Application Priority Data
Jun. 9, 2015 (JP) 2015-116476

(51) Int. Cl. H04L 12/24

(52) U.S. Cl. CPC H04L 41/14; H04L 41/12

(57) ABSTRACT

Provided are a network verification device, etc. capable of shortening the network verification time. The network verification device is provided with: a physical path acquisition means for acquiring physical path information relating to a pair of physical devices serving as endpoints of a physical path by which a communication packet is transmitted and received in a network to be verified; a virtual endpoint pair calculation means for calculating, on the basis of setting information of virtual devices in a virtual network which, by being associated with the network, is virtually set so as to transmit the communication packet using the network, a pair of virtual devices serving as endpoints of a virtual path set so as to transmit and receive the communication packet in the virtual network; and a violation detection means for detecting a setting violation in the network, on the basis of the physical path information acquired by the physical path acquisition means and the pair of virtual devices calculated by the virtual endpoint pair calculation means.

### TECHNICAL FIELD

The present invention relates to a network verification device, a network verification method and a program recording medium.

### BACKGROUND ART

An increasing number of enterprises and organizations are trying to apply virtualization technology to networks they are operating. As a reason of attracting attention, it is considered a point that, by virtualizing a network, a network operator can perform various kinds of control automatically and at a high speed by software. In the network virtualization technology, a virtual network having a corresponding relationship with actual devices constituting a physical network is built and operated.

FIG. 1 is a diagram which schematically indicates a configuration in which a virtual network built virtually is associated with (mapped to) a physical network built by physical devices. The virtual network includes a virtual path constituted of virtual devices set virtually, and transmits a communication packet to a destination from a source using an actual physical path and that is associated with the virtual path. The physical network illustrated in FIG. 1 includes a server 1, a server 2 and switches 1 to 4. The server 1 is connected to a port 1 of the switch 1, and the server 2 is connected to a port 1 of the switch 2, respectively.

In FIG. 1, by the configuration information of a virtual network, the switch 1 is associated with a virtual endpoint “vEx_1” which is an endpoint of the virtual network, and the switch 2 is associated with a virtual endpoint “vEx_2”. Thus, an endpoint of the virtual network is associated with one of the devices of the physical network. The virtual bridge “vBr_1” is disposed between the virtual endpoint “vEx_1” and the virtual endpoint “vEx_2”. Identification information (path ID (Identification)) of a path connecting the virtual endpoint “vEx_1”, the virtual endpoint “vEx_2” and the virtual bridge “vBr_1” is made to be path ID=“1”.

In a virtual network built as mentioned above, there is a possibility that the configuration information of a virtual network is not transmitted to a physical network by any trouble, causing a situation that the physical network becomes unsuitable for the design intention of an operator. Therefore, it is important for development of a network virtualization technology to secure reliability of the network virtualization technology by implementing network devices in which failure prevention is taken into consideration and by adopting a system etc. that verifies that the configuration information of a virtual network is transmitted to a physical network properly. In particular, when constructing a plurality of virtual networks in a physical network using Internet Protocol such as VLAN (Virtual Local Area Network), MPLS (Multi Protocol Label Switching) or the like to assign the virtual networks to a plurality of users, information should not be leaked to the other users.

Non-patent literature 1 discloses a method to verify reachability of communication between hosts and an isolation property of a virtual network defined for each user, by acquiring network configuration information including a transfer rule from a physical network and modeling the network. In the method disclosed in a non-patent literature 1, packet information is expressed as a header space, and the function of a network device is modeled as a mathematical function that gives a change to the header space. By such modeling, a host with whom an optional host can communicate and the header information of a packet at the time of its communication is calculated, and reachability of a packet in the present network configuration can be confirmed. Furthermore, by calculating a corresponding header space for each virtual network assigned to a user and then examining whether there is an overlapping part in the header spaces among all the virtual networks, it is possible to determine whether packet information leaks between users.

Here, as illustrated in FIG. 1, in a network virtualization technology, there are cases in which a virtual network and virtual devices that have a corresponding relationship with devices constituting an actual physical network are built to perform operation. In this virtual network, a packet filter setting of such as a firewall can be performed as with a usual physical network. In other words, in a tool to check the consistency between a virtual network and a physical network, a policy such as “only a packet with a predetermined address is allowed to pass” is read as a setting of a virtual network, and conditional determination whether a packet capable of passing through the physical network actually does not violate this policy is performed.

Non-patent literature 2 discloses a method in which, by rewriting the configuration information of a physical switch as an instance of a satisfiability problem (SAT: SATisfiability problem) and using an existing engine called a SAT solver, violation-possibility of a physical network is checked at a high speed without exception. Here, a violation indicates that a conduction path defined in a virtual network is unreachable in a physical network, for example. In the process of this check, all settings of physical switches including a filter setting are rewritten by Boolean algebra and reorganized by an existing optimization technique. Non-patent literature 2 also discloses an input data optimizing method of a SAT solver for speeding up setting-error detection.

Patent literature 1 discloses a method to verify the validity of a network system after configuration change in advance. In patent literature 1, the network configuration information is collected automatically into a verification server from a network system in operation, and a routing table of each network device is generated automatically. Then, by generating a routing table of the network after configuration change artificially and carrying out a path search, the connectivity of the network is verified.

Patent literature 2 discloses a method that extracts the configuration information from security equipment such as a firewall to generate a general purpose security policy of a form which does not depend on the specification of the equipment.

Patent literature 3 discloses a method to reduce the number of times of determination by performing caching of a conditional determination result in order to reduce a burden of a firewall processor.

Patent literature 4 discloses a rule analysis method that performs management of a filter rule set for a firewall etc. in a network, optimizes a set of complicated filter rules, and can determine uniformity of packet filter processing in a plurality of pieces of equipment.

### CITATION LIST

### Patent Literature

[Patent literature 1] Japanese Patent Application Laid-Open No. 2002-185512

[Patent literature 2] Japanese Patent Application Laid-Open No. 2006-040247

[Patent literature 3] Japanese Patent Application Laid-Open No. 1999-163940

[Patent literature 4] International Publication No. WO 2006/090781

[Patent literature 5] Published Japanese translation of PCT application No. 2013-510506

[Patent literature 6] Japanese Patent Application Laid-Open No. 2003-060678

### Non-patent Literature

[Non-patent literature 1] Peyman Kazemian, George Varghese, Nick McKeown, “Header Space Analysis: Static Checking For Networks”, NSDI'12 Proceedings of the 9th USENIX conference on Networked Systems Design and Implementation, 2012, pp. 9-22

[Non-patent literature 2] H. Ma et al. “Debugging the Data Plane with Anteater”, ACM SIGCOMM Computer Communication Review, 2011, pp. 290-301

### SUMMARY OF INVENTION

### Technical Problem

In the method described in non-patent literature 1, an amount of calculation equivalent to the order of the squire of the number of reachable physical paths is needed in order to check setting violations in a virtual network. Therefore, there is an issue that verification is difficult because, when a large number of virtual networks are set as is the case with a large scale network in a data center, for example, an enormous computing time is needed for detection of setting violations.

In the method described in non-patent literature 2, although physical network configuration information including a filter setting is optimized in the course of converting a problem of verifying a network to a satisfiability problem, verification of a network still takes a lot of time.

Also in patent literatures 1 to 4, there is no technology disclosed that enables reduction of network verification time.

The present invention has been made in view of the above issue and its object is to provide a network verification device that enables reduction of network verification time and the like.

### Solution to Problem

A network verification device according to one aspect of the present invention includes:

physical path acquisition means for acquiring physical path information relating to a pair of physical devices serving as endpoints of a physical path by which a communication packet is transmitted and received in a network to be verified;

virtual endpoint pair calculation means for calculating, based on configuration information of virtual devices in a virtual network that, by being associated with the network, is virtually set so as to transmit a communication packet using the network, a pair of the virtual devices serving as endpoints of a virtual path set so as to transmit and receive the communication packet in the virtual network; and

violation detection means for detecting a setting violation in the network, based on the physical path information acquired by the physical path acquisition means and the pair of the virtual devices calculated by the virtual endpoint pair calculation means.

A network verification method according to one aspect of the present invention includes:

acquiring physical path information relating to a pair of physical devices serving as endpoints of a physical path by which a communication packet is transmitted and received in a network to be verified;

calculating, based on configuration information of virtual devices in a virtual network that, by being associated with the network, is virtually set so as to transmit a communication packet using the network, a pair of the virtual devices serving as endpoints of a virtual path set so as to transmit and receive the communication packet in the virtual network; and

detecting a setting violation in the network, based on the acquired physical path information and the calculated pair of the virtual devices.

In addition, the object is also achieved by a computer program that achieves the network verification method having each of the above-described configurations with a computer, and a computer-readable recording medium that stores the computer program.

### Advantageous Effects of Invention

According to the present invention, an effect of shortening network verification time may be obtained.

### BRIEF DESCRIPTION OF DRAWINGS

FIG. 1 is an explanatory drawing illustrating a network being operated using a network virtualization technology.

FIG. 2 is a diagram illustrating a configuration of a network verification device according to a first example embodiment of the present invention.

FIG. 3 is a flow chart illustrating the outline of operations of a network verification device according to the first example embodiment of the present invention.

FIG. 4A is a diagram illustrating an example of configuration information of a physical device acquired by a network verification device according to the first example embodiment of the present invention.

FIG. 4B is a diagram illustrating an example of connection information between physical devices acquired by a network verification device according to the first example embodiment of the present invention.

FIG. 5 indicates an example of reachable-physical-path information generated by a path verification analysis unit of a network verification device according to the first example embodiment of the present invention.

FIG. 6 is a diagram illustrating an example of header information to be acquired by a network verification device according to the first example embodiment of the present invention.

FIG. 7 is a flow chart illustrating operations of a physical and virtual matching unit of a network verification device according to the first example embodiment of the present invention.

FIG. 8 is a diagram illustrating an example of virtual device configuration information acquired from a virtual network configuration input unit of a network verification device according to the first example embodiment of the present invention.

FIG. 9 is a diagram illustrating an example of virtual endpoint pair information generated by a virtual endpoint pair generation unit of a network verification device according to the first example embodiment of the present invention.

FIG. 10 is a flow chart illustrating operations of a connection path matching unit of a network verification device according to the first example embodiment of the present invention.

FIG. 11A is a diagram illustrating an example of connection matched path information stored in a connection matched path storage unit of a network verification device according to the first example embodiment of the present invention.

FIG. 11B is a diagram illustrating an example of wire connection matched path information stored in a wire connection matched path storage unit of a network verification device according to the first example embodiment of the present invention.

FIG. 12 is a block diagram illustrating a configuration of a network verification device according to a second example embodiment of the present invention.

FIG. 13 is a flow chart illustrating the outline of operations of a network verification device according to the second example embodiment of the present invention.

FIG. 14 is a flow chart illustrating operations by a packet transmission control unit of a network verification device according to the second example embodiment of the present invention.

FIG. 15 is a diagram illustrating a configuration of a network verification device according to a third example embodiment of the present invention.

FIG. 16 is a diagram exemplifying a hardware configuration of a network verification device according to each example embodiment of the present invention.

### DESCRIPTION OF EMBODIMENTS

Hereinafter, example embodiments of the present invention will be described in detail with reference to drawings.

### First Example Embodiment

### Description of Configuration

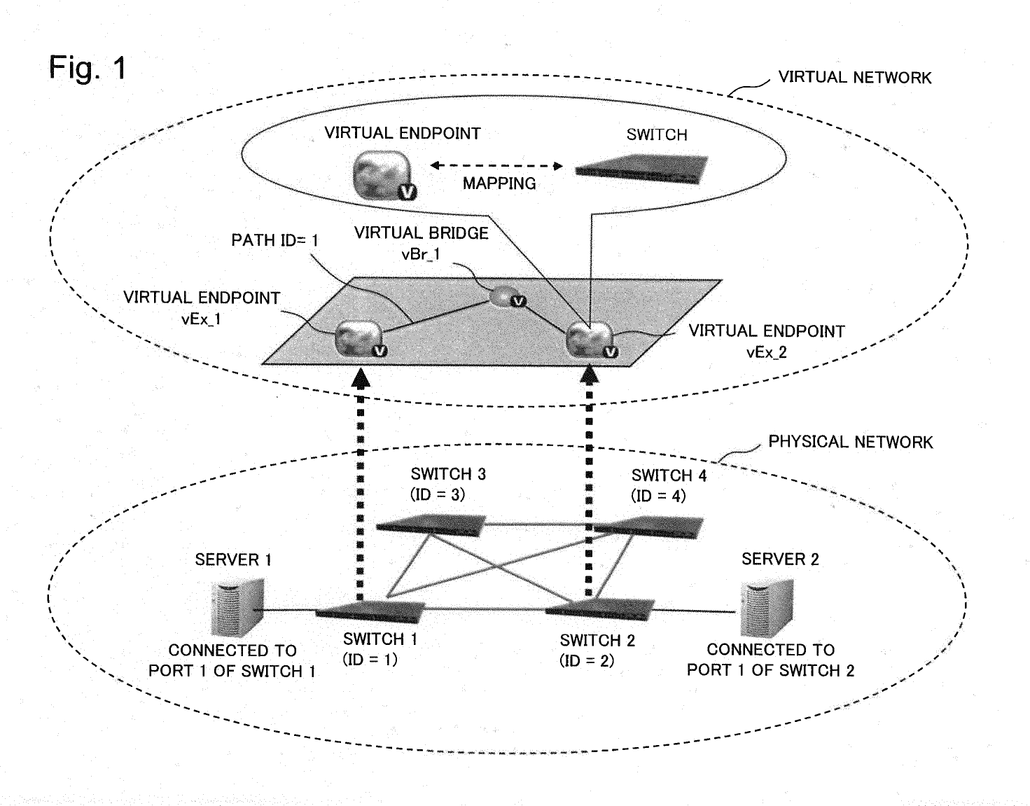

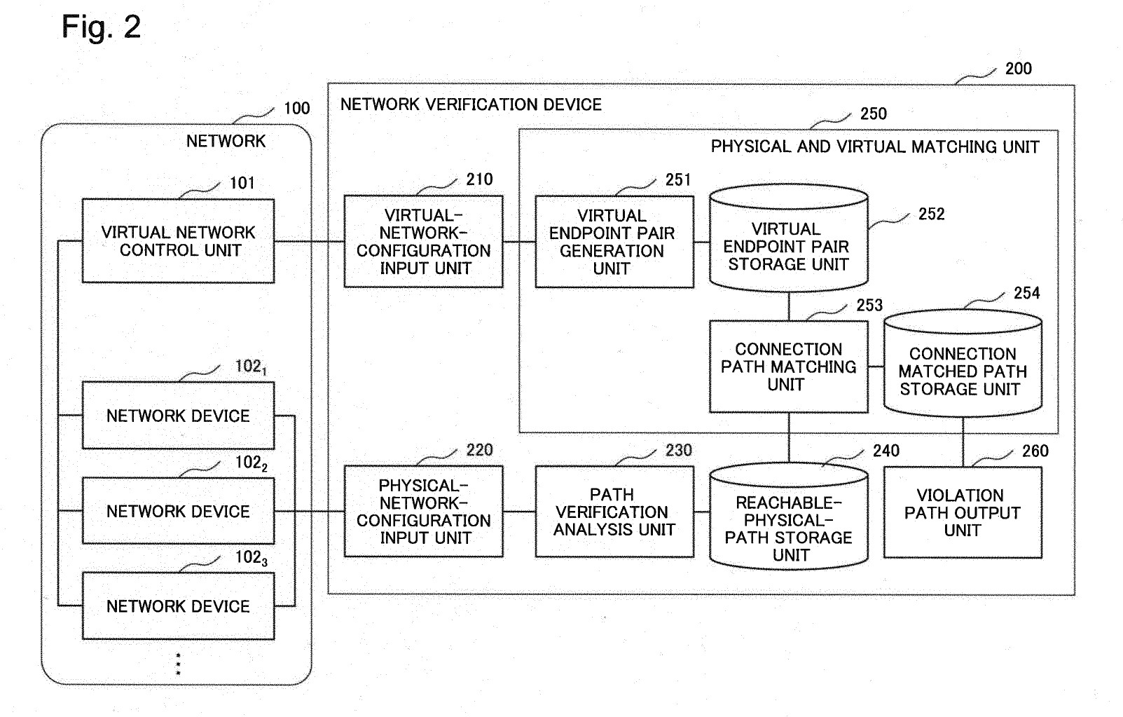

FIG. 2 is a diagram illustrating a configuration of a network verification device 200 according to the first example embodiment of the present invention. As illustrated in FIG. 1 schematically, a network 100 illustrated in FIG. 2 has a configuration in which the configuration information of a virtual network is mapped to an actual physical network. The network verification device 200 has a function to detect a setting mistake (setting violation) in the network 100.

In the network 100, there are provided a virtual network control unit 101 and one or more network devices 1021, 1022 and 1023 . . . (henceforth, these are collectively called “network device 102”) are arranged. The virtual network control unit 101 controls the network 100 according to a program.

The network 100 may be of a network environment controlled according to the OpenFlow protocol (OpenFlow network). In the following description, “a setting relating to a virtual network” may indicate a setting of an OpenFlow controller in an OpenFlow network environment, and “a setting relating to a physical network” may indicate a setting of an OpenFlow switch. The virtual network control unit 101 in FIG. 2 corresponds to an OpenFlow controller in an OpenFlow network environment, and the network device 102 corresponds to an OpenFlow switch. A virtual device controlled by the virtual network control unit 101 is disposed in a virtual network in the network 100.

In FIG. 2, the network verification device 200 acquires a setting relating to a virtual network and a setting relating to a physical network from the network 100, and detects an error of a setting of the network 100.

The network verification device 200 includes a virtual-network-configuration input unit 210, a physical-network-configuration input unit 220, a path verification analysis unit 230, a reachable-physical-path storage unit 240, a physical and virtual matching unit 250 and a violation path output unit 260.

The outline of each component will be described.

The virtual-network-configuration input unit 210 acquires, from the virtual network control unit 101, configuration information relating to the virtual network set to the network 100 by the virtual network control unit 101. The physical-network-configuration input unit 220 acquires, from the network device 102, configuration information of the network device 102 etc. (configuration information relating to a physical network).

The path verification analysis unit 230 calculates, on the basis of the configuration information relating to the physical network acquired by the physical-network-configuration input unit 220, an endpoint pair that is a pair of endpoints that are physically reachable and a path that connects the endpoint pair. The reachable-physical-path storage unit 240 stores the reachable endpoint pair of the physical network calculated by the path verification analysis unit 230 and the information on its path (reachable-physical-path information).

By checking the configuration information relating to the physical network against the configuration information relating to the virtual network, the physical and virtual matching unit 250 detects a violation path caused by a setting mistake. The violation path output unit 260 outputs a violation path detected by the physical and virtual matching unit 250.

The physical and virtual matching unit 250 includes a virtual endpoint pair generation unit 251, a virtual endpoint pair storage unit 252, a connection path matching unit 253 and a connection matched path storage unit 254.

The virtual endpoint pair generation unit 251 analyzes configuration information relating to virtual devices set to the virtual network and connection information between the virtual devices. Then, the virtual endpoint pair generation unit 251 calculates a virtual endpoint pair that is a pair of endpoints reachable in the virtual network, and generates virtual endpoint pair information including the virtual endpoint pair. The virtual endpoint pair storage unit 252 stores the virtual endpoint pair information generated by the virtual endpoint pair generation unit 251.

The connection path matching unit 253 refers to the virtual endpoint pair information generated by the virtual endpoint pair generation unit 251 and the reachable-physical-path information calculated by the path verification analysis unit 230 to calculate a violation path. The connection matched path storage unit 254 stores the information about a violation path which the connection path matching unit 253 has calculated.

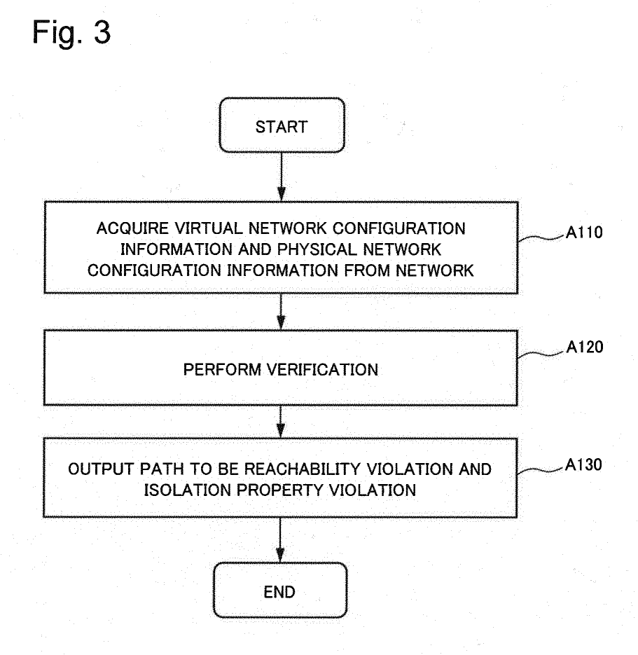

FIG. 3 is a flow chart illustrating the outline of operations of the network verification device 200. The outline of operations of the network verification device 200 will be described with reference to FIG. 3.

The network verification device 200 acquires configuration information from the network 100 (A110). That is, the virtual-network-configuration input unit 210 acquires configuration information of a virtual network. The physical-network-configuration input unit 220 acquires configuration information of a physical network.

Next, the physical and virtual matching unit 250 refers to the acquired information, and performs verification of a path and detects a violation (A120). Next, the violation path output unit 260 outputs a violation obtained as a result of the verification by the physical and virtual matching unit 250, that is, a path detected as a reachability violation or an isolation property violation (detailed description will be made later) (A130).

Next, operations of the path verification analysis unit 230 will be described. The path verification analysis unit 230 acquires configuration information relating to the network device 102 (physical device) of the physical network from the physical-network-configuration input unit 220. Then, based on the configuration information, the path verification analysis unit 230 generates reachable-physical-path information including information about the starting point and the end point of a reachable endpoint pair of the physical network.

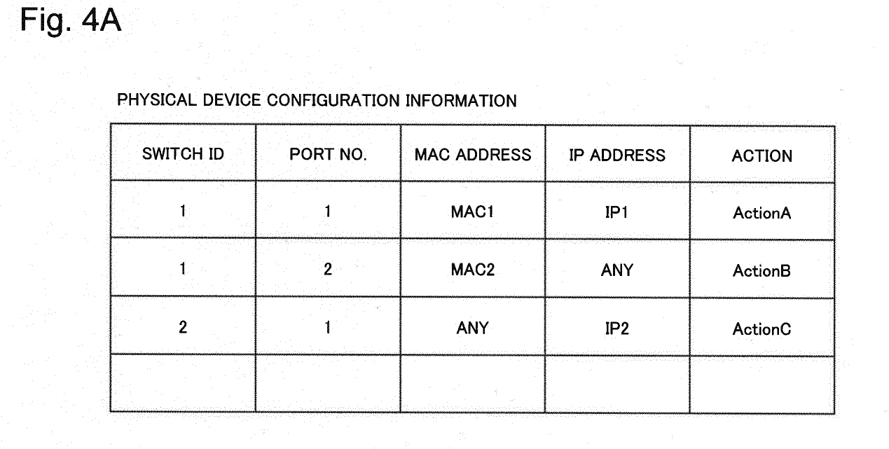

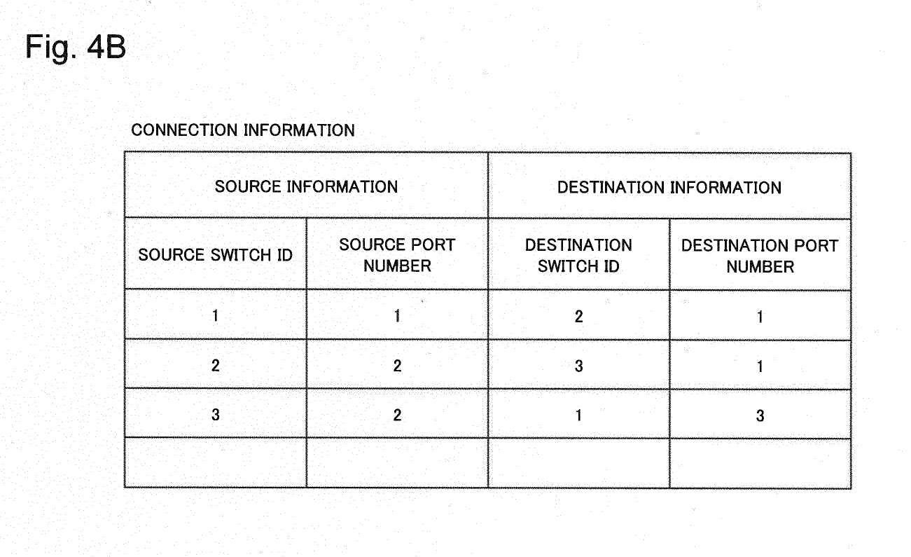

FIG. 4A and FIG. 4B are diagrams illustrating an example of information about setting of physical devices. FIG. 4A indicates an example of configuration information of physical devices. FIG. 4B indicates an example of connection information between physical devices. As illustrated in FIG. 4A, the configuration information of physical devices includes, for each switch that is a physical device, identification information (switch ID), a port number, a MAC (Media Access Control) address, an IP (Internet Protocol) address and an action. In FIG. 4A, it is indicated that, the MAC address set to the port of the port number=“1” of the switch having the switch ID=“1” is “MAC1”, the IP address is “IP1” and the action is “Action A”, for example.

As illustrated in FIG. 4B, connection information between physical devices includes information on switch ports being connected to each other. That is, the connection information between physical devices includes, for a source and a destination to be connected, source information including the ID of a source switch and the number of a source port, and destination information including the ID of a destination switch and the number of a destination port, the source switch and the source port. In FIG. 4B, it is illustrated that the port number=“1” of the switch having the switch ID=“1” to be a source is connected in a manner taking the port number=“1” of the switch having the switch ID=“2” as a destination, for example.

The path verification analysis unit 230 acquires configuration information of physical devices and connection information between physical devices as described above from the physical-network-configuration input unit 220 and generates reachable-physical-path information based on the acquired information.

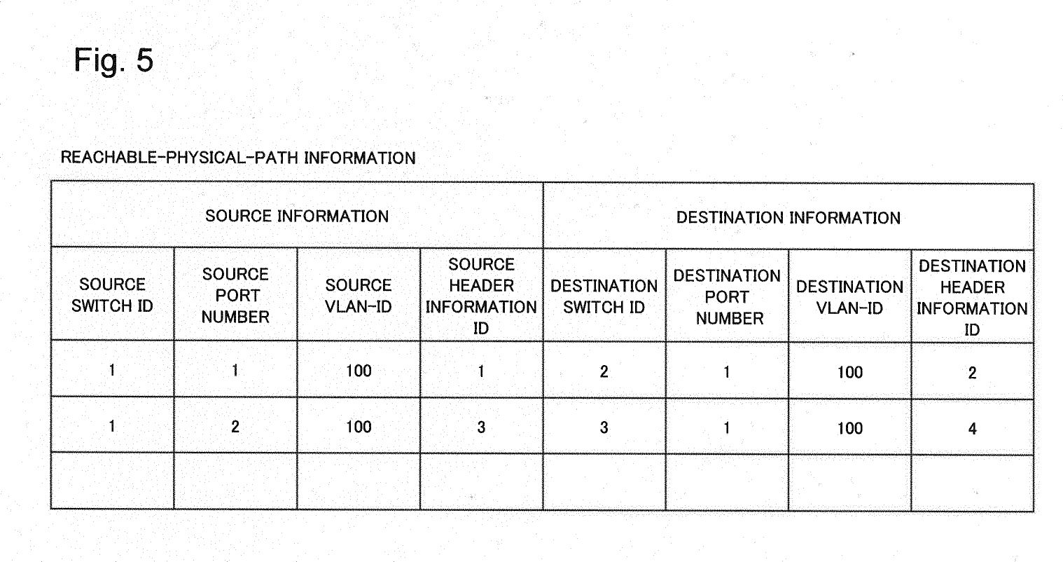

FIG. 5 indicates an example of reachable-physical-path information generated by the path verification analysis unit 230. In the reachable-physical-path information, for each reachable endpoint pair of a physical network, source information about a source (starting point) and destination information about a destination (end point) are stored in a state associated with each other. The source information includes a source switch ID, a source port number, a source VLAN-ID and a source header information ID. The destination information includes a destination switch ID, a destination port number, a destination VLAN-ID and a destination header information ID.

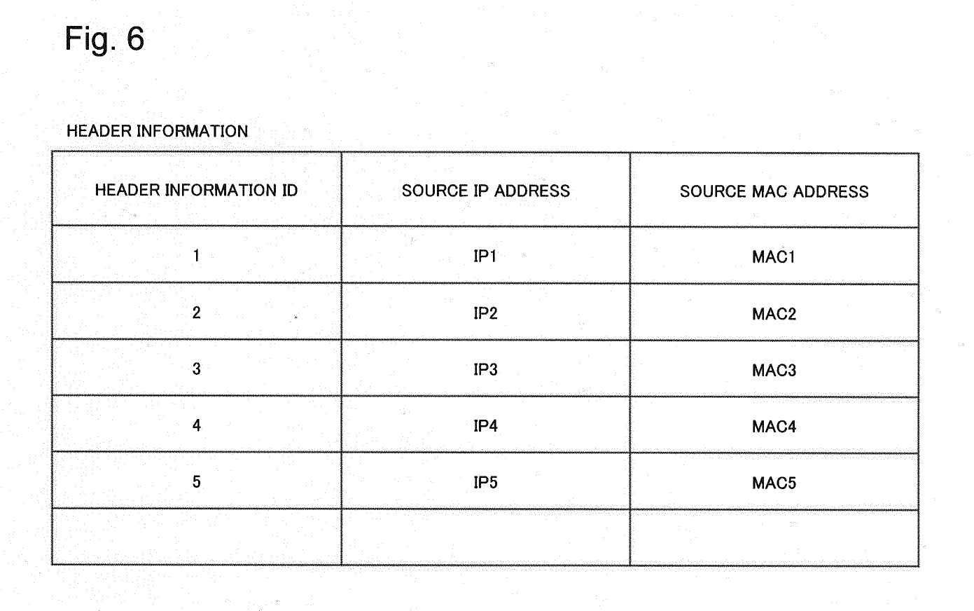

The source switch ID and the source port number are information specific to a switch. The source VLAN-ID is information for association with an endpoint of a virtual network. The source header information ID is the ID for a header pattern (header information) including packet information such as an IP address of a source of a packet to be transmitted and the like. FIG. 6 is a diagram illustrating an example of the header information. In the example of FIG. 6, the header information includes a set of the source IP address and the source MAC address of a packet, and an ID is assigned to the set. Each item included in the destination information of FIG. 5 is similar to the above-mentioned item included in the source information.

The path verification analysis unit 230 may generate reachable-physical-path information as illustrated in FIG. 5 using the technology indicated in non-patent literature 1, for example, in search of a reachable endpoint pair of a physical network. Specifically, the path verification analysis unit 230 may perform modeling by taking a header pattern as a bit string and an operation of a network device as a transfer function that acts on the bit string to obtain a header pattern that is permitted in order to arrive at an endpoint from a starting point of network devices.

The path verification analysis unit 230 stores the reachable-physical-path information generated as above in the reachable-physical-path storage unit 240.

The violation path output unit 260 outputs information on a kind of a violation caused by a setting mistake, a violating physical path and corresponding virtual network endpoints. The kind of a violation includes a violation of reachability and a violation of an isolation property. The violation of reachability in this example embodiment corresponds to a case where, though a path is reachable in the setting of the virtual network, the corresponding path does not exist in the physical network. The violation of an isolation property in this example embodiment corresponds to a case where, though a path is not reachable in the setting of the virtual network, a corresponding path exists in the physical network. The violation of reachability occurs when, for example, the configuration information of the virtual network is not transmitted to physical devices by some kind of trouble, and, by this, a physical path intended by a network operator is not set to the physical network. The violation path output unit 260 may indicate, for example, a violation path in a manner enumerating information on the kind of a violation and a violation path by a command line, or indicate a violation path in a manner combined with a virtual or physical network topology by a GUI (Graphical User Interface), or output as a data file.

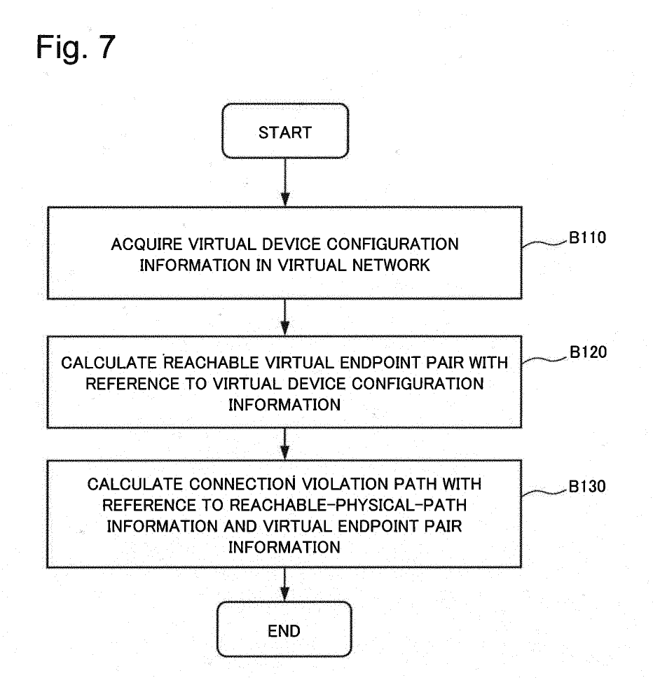

Next, operations of the physical and virtual matching unit 250 will be described. First, the outline of operations of the physical and virtual matching unit 250 will be described with reference to FIG. 7.

The virtual endpoint pair generation unit 251 of the physical and virtual matching unit 250 acquires configuration information of virtual devices (henceforth, also referred to as “virtual device configuration information”) setup in the virtual network from the virtual-network-configuration input unit 210 (B110).

The virtual endpoint pair generation unit 251 refers to the virtual device configuration information acquired from the virtual-network-configuration input unit 210, and calculates a reachable virtual endpoint pair (B120).

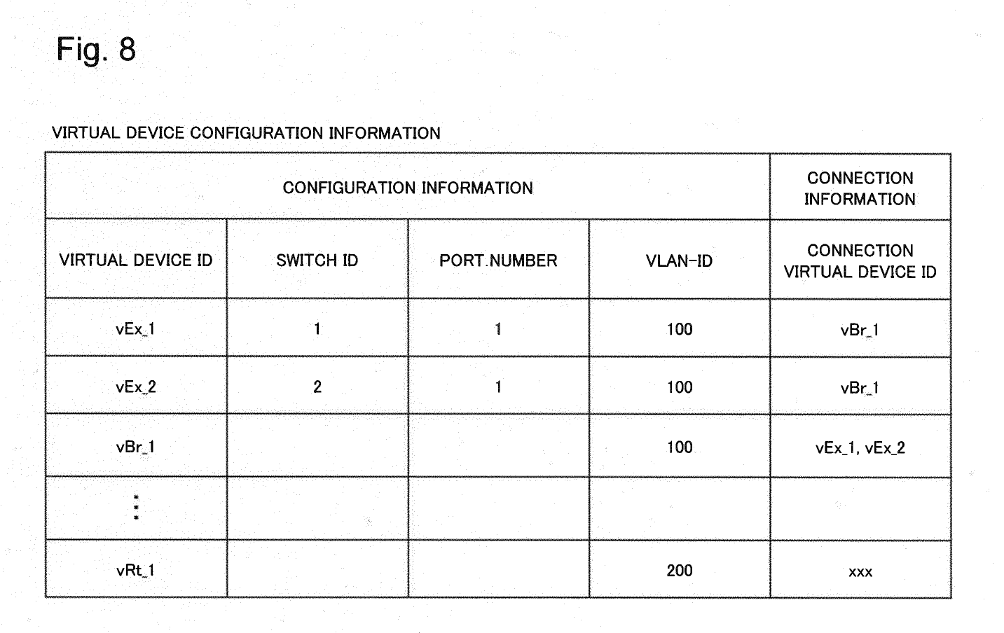

FIG. 8 is a diagram illustrating an example of the virtual device configuration information acquired from the virtual-network-configuration input unit 210. As illustrated in FIG. 8, the virtual device configuration information includes configuration information and connection information. Here, a virtual device includes, not only an endpoint (virtual endpoint) of a virtual network, but also a virtual device such as a virtual router, a virtual bridge, or the like that can be disposed in the middle of a path. The configuration information includes information to make a device be identified in a virtual network such as a virtual device ID and the like.

When a virtual device is a virtual endpoint (virtual device ID=“vEx_1” and “vEx_2” in the example illustrated in FIG. 8), the ID and a port number of a switch that is a physical endpoint (physical device) associated with a virtual device are also included in the configuration information.

The connection information includes the connection virtual device ID. The connection virtual device ID is the ID for a virtual device (connection virtual device) that has been set in a manner being adjacent to the virtual device defined in the setting information. For example, in the case of the virtual network illustrated in FIG. 1, the virtual device with virtual device ID=“vBr_1” is connected to a virtual device “vEx_1” and “vEx_2”. Accordingly, connection information corresponding to virtual device ID=“vBr_1” will be “vEx_1” and “vEx_2”. Also, connection information corresponding to both virtual devices ID=“vEx_1” and “vEx_2” will be “vBr_1”.

The virtual endpoint pair generation unit 251 acquires the above-mentioned virtual device configuration information from the virtual-network-configuration input unit 210, and obtains the connection states of the whole virtual network as illustrated in FIG. 1 by linking the connection information of each virtual device. Then, the virtual endpoint pair generation unit 251 calculates all reachable virtual endpoint pairs based on the obtained connection states in the virtual network. Referring to the virtual device configuration information illustrated in FIG. 8, for example, the virtual endpoint pair generation unit 251 detects that a path which starts from a virtual end point “vEx_1” goes to “vBr_1” that is a connection virtual device of “vEx_1”, and then goes to “vEx_2” that is a connection virtual device of “vBr_1” and that serves as an endpoint. Accordingly, the virtual endpoint pair generation unit 251 calculates “vEx_1” and “vEx_2” as a virtual endpoint pair.

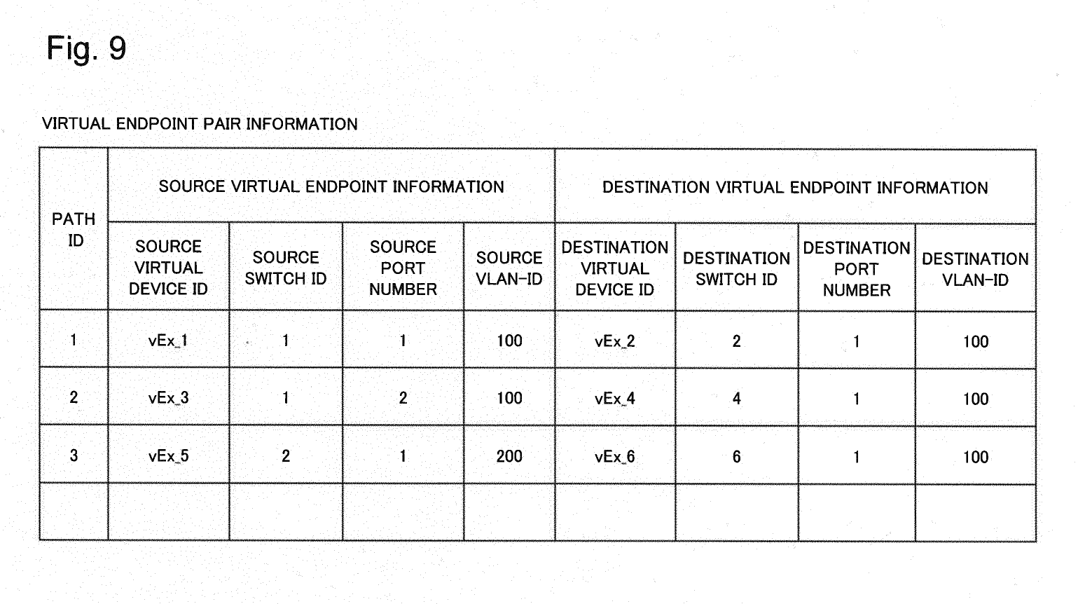

Next, the virtual endpoint pair generation unit 251 generates virtual endpoint pair information based on the calculated virtual endpoint pair. FIG. 9 is a diagram illustrating an example of the virtual endpoint pair information which the virtual endpoint pair generation unit 251 has generated. The path ID is assigned to the virtual endpoint pair.

The virtual endpoint pair generation unit 251 generates virtual endpoint pair information, to which the path ID has been assigned, including source virtual endpoint information and destination virtual endpoint information. The virtual endpoint pair generation unit 251 sets “vEx_1” of the calculated virtual endpoint pair to the source virtual device ID and sets “vEx_2” to the destination virtual device ID respectively.

The virtual endpoint pair generation unit 251 also includes, in virtual endpoint pair information, the ID and a port number of a switch and a VLAN-ID that are required for associating a source virtual device ID and a destination virtual device ID with physical endpoints, respectively. The virtual endpoint pair generation unit 251 stores the generated virtual endpoint pair information in the virtual endpoint pair storage unit 252.

Next, as illustrated in B130 of FIG. 7, by performing matching of the virtual endpoint pair information in the virtual network acquired from the virtual endpoint pair storage unit 252 and the reachable-physical-path information acquired from the reachable-physical-path storage unit 240, the connection path matching unit 253 calculates a path of an isolation property violation (Isolation) or a reachability violation (Reachability).

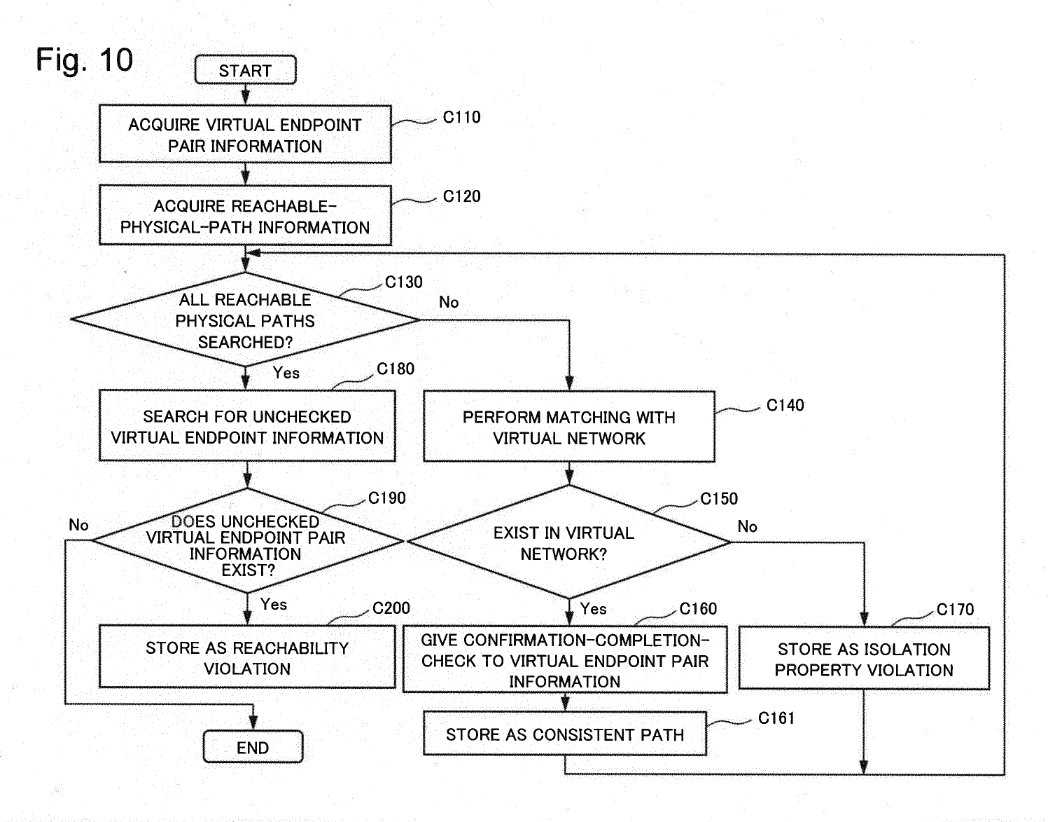

FIG. 10 is a flow chart illustrating operations to calculate a path to be a connection violation by the connection path matching unit 253. With reference to FIG. 10, operations of the connection path matching unit 253 will be described.

First, the connection path matching unit 253 acquires virtual endpoint pair information from the virtual endpoint pair storage unit 252 (C110). The connection path matching unit 253 acquires reachable-physical-path information from the reachable-physical-path storage unit 240 (C120).

Next, the connection path matching unit 253 searches the reachable physical paths on the basis of virtual endpoint pair information (C130). That is, when searching of all reachable physical paths has not been ended yet (in C130, No), the connection path matching unit 253 performs matching of the virtual endpoint pair information in question and a reachable physical path, and examines whether a reachable physical path exists in the virtual network (C140). The connection path matching unit 253 uses the source information and the destination information included in the reachable-physical-path information illustrated in FIG. 5 for the search. That is, the connection path matching unit 253 examines whether there exists, in the virtual endpoint pair information in question, a pair of: source virtual endpoint information and destination virtual endpoint information, the source virtual endpoint information matching the source switch ID, the source port number and the source VLAN-ID of the source information included in the reachable-physical-path information, the destination virtual endpoint information matching the destination switch ID, the destination port number and the destination VLAN-ID of the destination information, both included in the reachable-physical-path information.

When such pair exists in the virtual endpoint pair information (in C150, Yes), the connection path matching unit 253 determines that a reachable physical path exists in the virtual network, and gives a mark (check) indicating that confirmation has been completed to the virtual endpoint pair information in question (C160). Then, the connection path matching unit 253 stores a path indicated by the virtual endpoint pair information in the connection matched path storage unit 254 as a consistent path (C161).

On the other hand, when such pair does not exist in the virtual endpoint pair information (in C150, No), the connection path matching unit 253 determines that a reachable physical path does not exist in the virtual network, and stores the path in the connection matched path storage unit 254 as a violation path belonging to an isolation property violation (C170).

For example, the source information of the reachable-physical-path information indicated in the first line of FIG. 5 is mapped to the virtual endpoint “vEx_1” in the network configuration illustrated in FIG. 1 grasped as mentioned above, and the destination information is mapped to the virtual endpoint “vEx_2”. Referring to FIG. 9, the path generated by this mapping is identical with the path of ID=“1” that is a path formed by the source virtual device of ID=“vEx_1” and the destination virtual device of ID=“vEx_2”. The connection path matching unit 253 determines that the path having the path ID=“1” is a consistent path, stores it in the connection matched path storage unit 254, and gives a check indicating confirmation-completed to the virtual endpoint pair information.

On the one hand, about reachable-physical-path information indicated in the second line of FIG. 5, although the endpoint indicated by the source information matches the endpoint indicated by the source virtual endpoint information of the virtual endpoint pair information in the second line of FIG. 9, the endpoint indicated by the destination information and the endpoint indicated by the destination virtual endpoint information do not match each other. Accordingly, the path indicated by the reachable-physical-path information in question is determined as an isolation property violation.

The connection path matching unit 253 performs the above-mentioned search with respect to all reachable physical paths and when the search ends with respect to all the paths (in C130, Yes), the connection path matching unit 253 searches for unchecked virtual endpoint pair information (C180). When unchecked virtual endpoint pair information exists (in C190, Yes), the connection path matching unit 253 stores a path indicated by the virtual endpoint pair formation in question in the connection matched path storage unit 254 as a violation path belonging to a reachability violation (C200).

Information that is obtained by matching of virtual endpoint pair information and a reachable physical path by the connection path matching unit 253 and is stored in the connection matched path storage unit 254 as mentioned above is called “connection matched path information”.

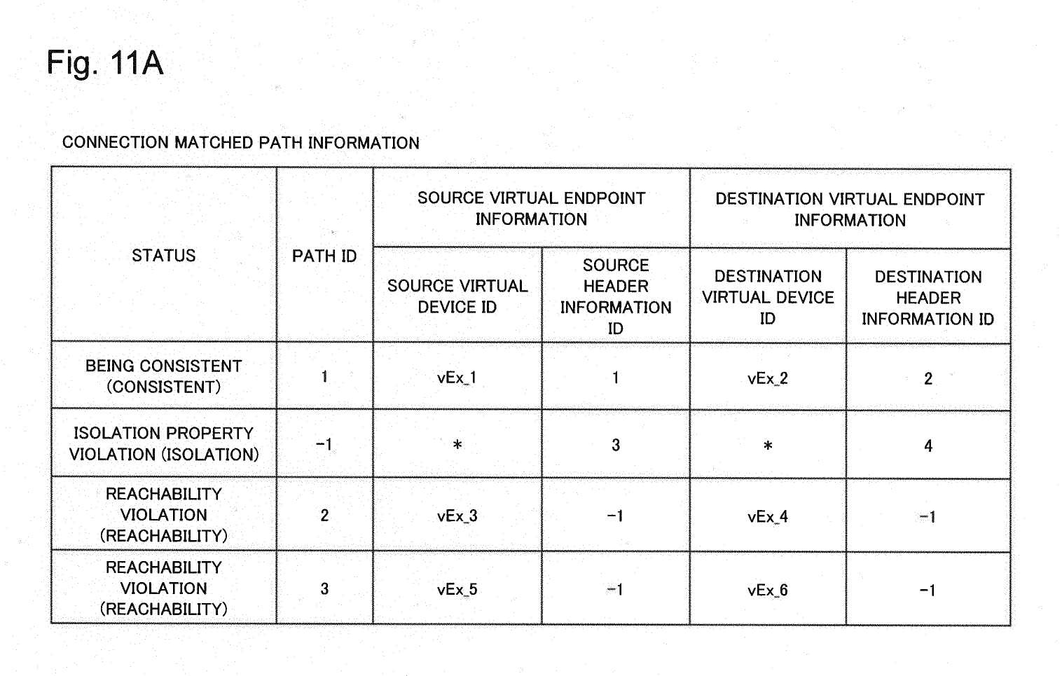

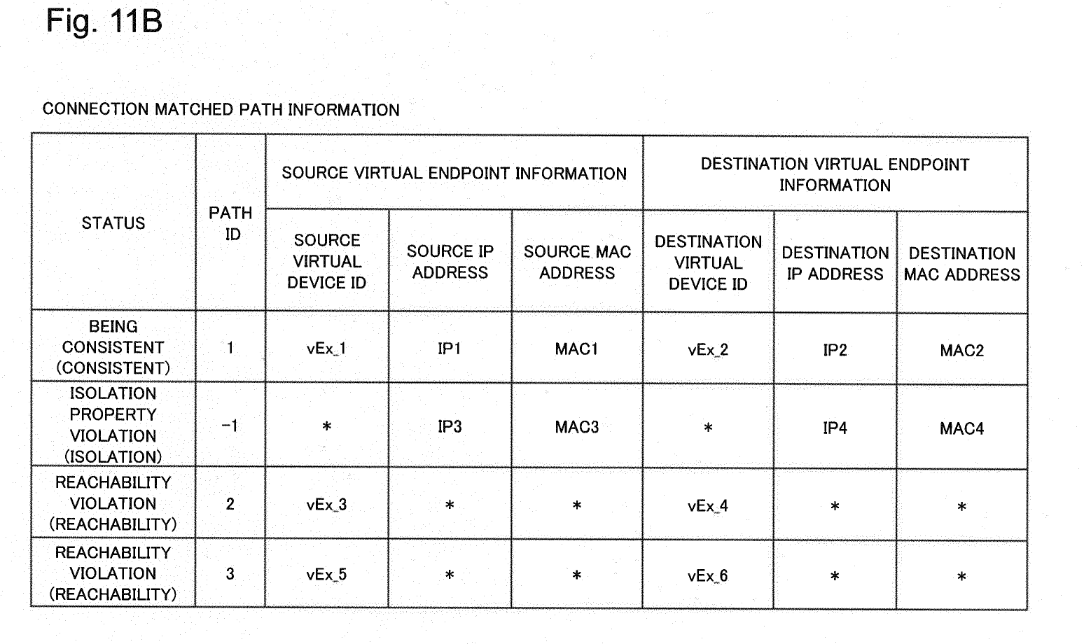

FIG. 11A and FIG. 11B are diagrams illustrating an example of connection matched path information stored in the connection matched path storage unit 254. The connection matched path information illustrated in FIG. 11A and FIG. 11B includes, for each path detected as a result of the above-mentioned matching by the connection path matching unit 253, a status, the path ID and the endpoint information of the virtual network (source virtual endpoint information and destination virtual endpoint information).

As illustrated in FIG. 11A, as a kind of violations, an isolation property violation and a reachability violation are indicated in the status. In the status of a path without a violation, the letter, Consistent, is indicated. The source virtual endpoint information includes a source virtual device ID and a source header information ID extracted from the reachable-physical-path information (when the status is an isolation property violation and being consistent). The destination virtual endpoint information includes a destination virtual device ID and a destination header information ID extracted from the reachable-physical-path information (when the status is an isolation property violation and being consistent).

Note that, in the case of a reachability violation, since there is no packet information corresponding to the physical network, it may be specified that there is no packet to be a target by setting the numerical value of a source header information ID and a destination header information ID to “−1”, “*” or the like. In addition, since, in an isolation property violation, a physical path which is not included in the virtual paths corresponds to this violation, that is, there is no virtual path to be a target, it may be clearly indicated that there is no target virtual path by setting a numerical value of “−1”, “*” or the like to a path ID.

Furthermore, as illustrated in FIG. 11B, the concrete values of the IP addresses and the MAC addresses of a source and a destination of a packet may be included in the connection matched path information instead of a source header information ID and a destination header information ID.

The connection path matching unit 253 stores the connection matched path information generated as mentioned above in the connection matched path storage unit 254.

The violation path output unit 260 outputs the connection matched path information as illustrated in FIG. 11A or FIG. 11B stored in the connection matched path storage unit 254 to a network administrator using, for example, GUI display, data file output, or the like.

As above, according to the first example embodiment, the network verification device 200 calculates, based on the configuration information of the virtual network acquired from the virtual network control unit 101, a virtual endpoint pair that is a pair of reachable endpoints in the virtual network. Then, the connection path matching unit 253 performs matching between: a pair of endpoints that forms a reachable physical path calculated based on configuration information and connection information about the physical devices of the network 100; and a virtual endpoint pair. The connection path matching unit 253 detects, as a path of an isolation property violation, a physical path for which a virtual endpoint pair that accords with the pair of endpoints forming the reachable physical path does not exist.

By adopting the aforementioned configuration, there is obtained an effect that verification of a path of an isolation property violation can be performed at a high speed, because, in contrast with a usual case where verification of a setting violation of a virtual network takes a computing time of the order of the square of the reachable number of physical paths, verification of a path can be made in a computing time of the order of the number of reachable physical paths.

### The Second Example Embodiment

### Description of Configuration

Next, the second embodiment based on the first example embodiment mentioned above will be described with reference to a drawing. In the following description, by giving the same reference number to a configuration similar to that of the first example embodiment, overlapped description will be omitted.

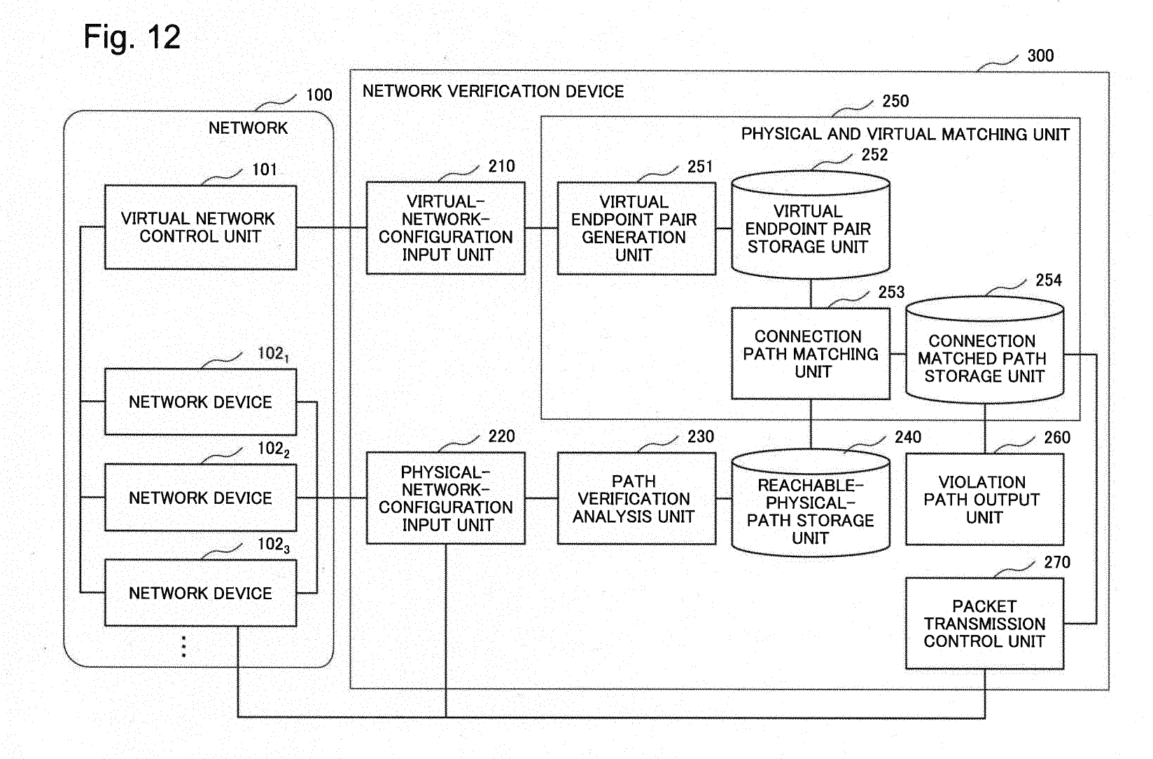

FIG. 12 is a block diagram illustrating a configuration of a network verification device 300 according to the second example embodiment of the present invention. As illustrated in FIG. 12, the network verification device 300 according to the second example embodiment includes a packet transmission control unit 270 in addition to the configuration of the network verification device 200 described in the first example embodiment.

The packet transmission control unit 270 performs control in such a way that a packet is transmitted from the network device 102 in the network 100.

In the network 100, there is a case where, although there is a physical path corresponding to a virtual path in a virtual network, configuration information relating to the virtual path may not be set to the network device 102 properly. This arises because, for example, configuration information set to the network device 102 is deleted due to a time limit, or a required setting has not been competed because of timing.

In such case, there is a possibility that the connection path matching unit 253 has determined that a path which should not fall under a reachability violation is in violation of reachability. Therefore, in the second example embodiment, it will be described that control is carried out by the packet transmission control unit 270 so as to transmit a packet from the network device 102, and, by analyzing a result of this, the accuracy of a determination of a reachability violation by the connection path matching unit 253 is improved.

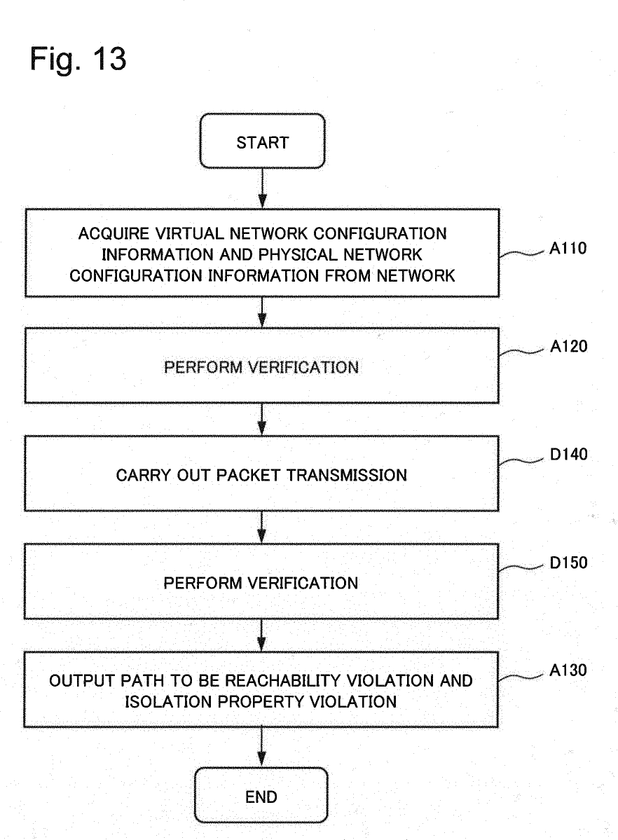

FIG. 13 is a flow chart illustrating the outline of operations of the network verification device 300. In FIG. 13, the processing indicated in A110, A120 and A130 is similar to the processing of A110, A120 and A130 illustrated in FIG. 2. According to the second example embodiment, the network verification device 300 carries out processing D140 by the packet transmission control unit 270 following the processing A120, and then performs verification in D150 based on a result of the processing D140.

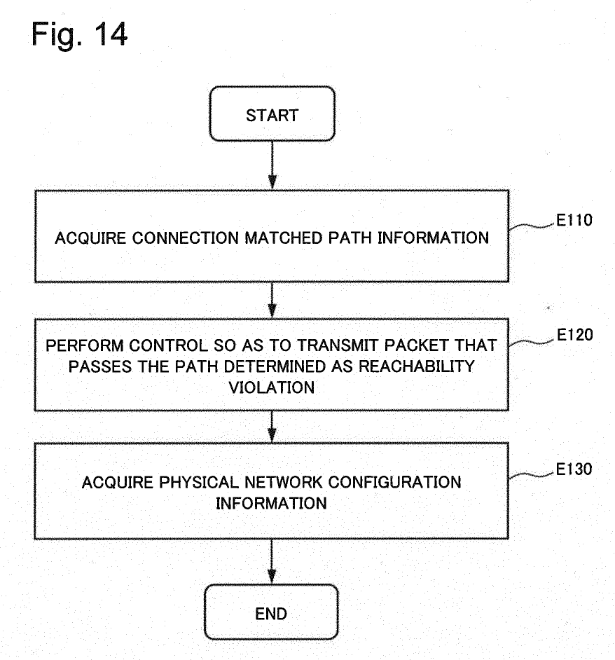

FIG. 14 is a flow chart that specifically indicates the processing D140 of FIG. 13 by the packet transmission control unit 270. Operations of the packet transmission control unit 270 will be described with reference to FIG. 14.

When execution of verification indicated in A120 of FIG. 13 ends, the packet transmission control unit 270 reads the connection matched path information stored in the connection matched path storage unit 254 (E110).

Next, the packet transmission control unit 270 extracts information on a path having the status of “reachability violation” from the connection matched path information that has been read. Here, description will be made using the connection matched path information illustrated in FIG. 11A described in the first example embodiment. The packet transmission control unit 270 extracts the connection matched path information about path ID=“2”, for example. In the network 100, the packet transmission control unit 270 performs control so as to transmit a packet that will pass the path indicated by path ID=“2” (E120).

That is, the packet transmission control unit 270 makes the switch of the source of the path of path ID=“2” transmit a packet to the switch of the destination. As illustrated in FIG. 11A, the source virtual endpoint in the path of path ID=“2” is “vEx_3” and the destination virtual endpoint is “vEx_4”. Referring to FIG. 9, information on the switch corresponding to the virtual device ID=“vEx_3” is the switch ID=“1”, the port number=“2” and the VLAN-ID=“100”. Further, information on the switch corresponding to the virtual device ID=“vEx_4” is the switch ID=“4”, the port number=“1” and the VLAN-ID=“100”.

Accordingly, the packet transmission control unit 270 makes a packet be transmitted from the port of the number=“2” of the switch of the ID=“1” via the VLAN of ID=“100”. At that time, the packet transmission control unit 270 sets the IP address and the MAC address of the port of the number=“1” of the switch of the ID=“4” to the destination IP address and the destination MAC address of the packet, respectively, and sets “100” to the destination VLAN-ID.

Devices in the network 100 operate as follows along with the transmission of the above-mentioned packet. That is, the switch of the ID=“1” that is a source searches for the condition of transfer control (the transfer condition) about the above-mentioned packet from a flow-table stored in itself. Here, since the path of path ID=“2” has been determined to be a reachability violation, the switch of the ID=“1” does not have the transfer condition about the packet. Accordingly, the switch of the ID=“1” inquires to the virtual network control unit 101 about the transfer condition.

The virtual network control unit 101 that has received the inquiry generates a transfer condition for the above-mentioned packet. Then, the virtual network control unit 101 transmits the generated transfer condition to network devices through which the packet is made to be transferred in the network 100.

The network devices that have received the transfer condition store the transfer condition in the own flow-table, and transmit the packet to the destination following the transfer condition.

As mentioned above, by a packet being transmitted by the packet transmission control unit 270, the virtual network control unit 101 generates a transfer condition and transmits the transfer condition to a network device. As a result, regarding a path that is actually not a reachability violation and can transmit a packet properly, the physical network configuration information is changed so as to allow a packet to be transmitted as being set in the virtual path.

As mentioned above, the packet transmission control unit 270 performs control about all paths having the status of “reachability violation” in such a way that a packet is transmitted from the source to the destination.

When transmission of a packet ends about paths of all of the above-mentioned reachability violations, the packet transmission control unit 270 instructs the physical-network-configuration input unit 220 to acquire physical network configuration information once again (E130).

Based on the physical network configuration information acquired in processing E130 and the virtual network configuration information acquired in processing A110 of FIG. 13, the network verification device 300 performs verification (D150). That is, as it has been described with reference to FIG. 10 in the first example embodiment, the connection path matching unit 253 verifies a path by performing matching of the reachable-physical-path information and the virtual endpoint pair information. Then, as a result of the verification, the network verification device 300 outputs paths of a reachability violation and an isolation property violation that have been detected (A130).

As above, according to the second example embodiment, the network verification device 300 performs, about a path that may have been determined as a reachability violation due to erroneous setting of configuration information of network devices in the network 100, control in such a way that a packet is transmitted through the path. After transmission of the packet, the network verification device 300 acquires physical network configuration information once again and performs verification similar to the verification described in the first example embodiment based on the acquired physical network configuration information and the virtual network configuration information. As a result, according to this second example embodiment, an effect that accuracy of determination of a reachability violation can be improved is obtained because, about a path that may have been determined as a reachability violation due to erroneous setting of configuration information of network devices, it is possible to determine that the path is not in violation of reachability by acquiring correct physical network configuration information.

### The Third Example Embodiment

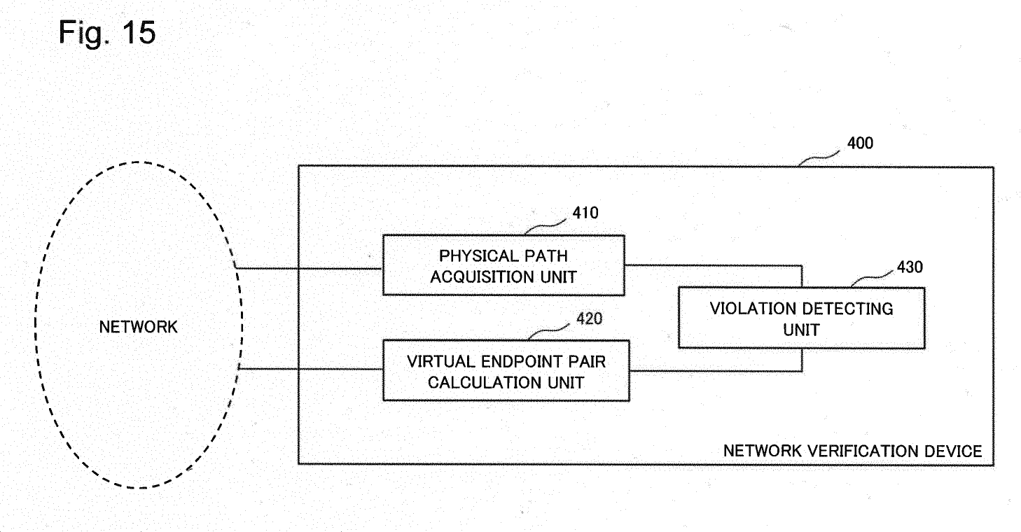

FIG. 15 is a diagram illustrating a configuration of a network verification device 400 according to the third example embodiment of the present invention. The network verification devices 200 and 300 in the first and the second example embodiment are based on the network verification device 400 according to the third example embodiment. As illustrated in FIG. 15, the network verification device 400 includes a physical path acquisition unit 410, a virtual endpoint pair calculation unit 420, and a violation detecting unit 430.

The physical path acquisition unit 410 acquires physical path information about a pair of physical devices serving as endpoints of a physical path through which a communication packet is transmitted and received in a network to be verified. By being associated with the network, the virtual endpoint pair calculation unit 420 calculates, based on configuration information of virtual devices in a virtual network which has been set virtually so as to transmit a communication packet using the network, a pair of virtual devices serving as the endpoints of a virtual path set so as to transmit and receive a communication packet in the virtual network.

The violation detecting unit 430 detects a setting violation in the network based on the physical path information acquired by the physical path acquisition unit 410 and the pair of virtual devices calculated by the virtual endpoint pair calculation unit 420.

Meanwhile, the physical path acquisition unit 410 and the violation detecting unit 430 correspond to the connection path matching unit 253 in the first example embodiment, and the virtual endpoint pair calculation unit 420 corresponds to the virtual endpoint pair generation unit 251.

By adopting the aforementioned configuration, an effect that verification of a violation path can be performed at a higher speed is obtained according to the third example embodiment, because a path can be verified by a computing time of the order of the number of pieces of physical path information.

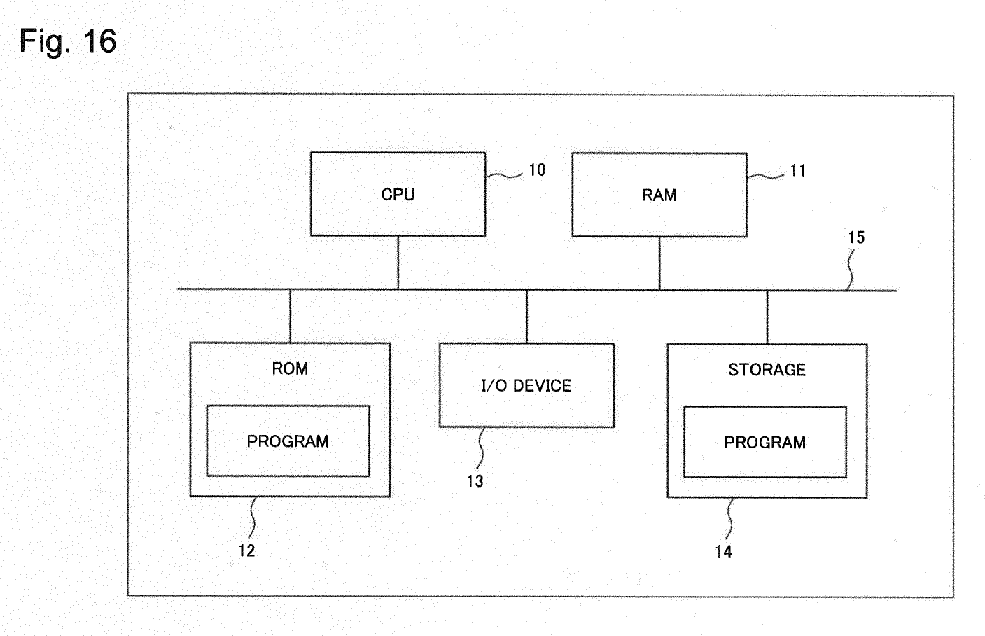

Meanwhile, each unit of a network verification device indicated in FIG. 2 and the like is realized in the hardware resources illustrated in FIG. 16. That is, the configuration illustrated in FIG. 16 includes a CPU (Central Processing Unit) 10, a RAM (Random Access Memory) 11, a ROM (Read Only Memory) 12, an I/O (Input/Output) device 13, and a storage 14. By reading various software programs (computer programs) stored in the ROM 12 or the storage 14 into the RAM 11 and executing these, the CPU 10 controls overall operations of the network verification device. That is, in each of the above-mentioned example embodiments, the CPU 10 executes a software program which performs each function (each unit) of the network verification device, referring to the ROM 12 or the storage 14 as needed.

In each of the example embodiments mentioned above, as an example in which the CPU 10 illustrated in FIG. 16 performs the functions indicated in each block in the network verification device indicated in FIG. 2 and the like, a case where the functions are realized by a software program has been described. However, a part or all of the functions illustrated in each block indicated in FIG. 2 and the like may be realized as hardware.

The present invention that has been described taking each example embodiment as an example is achieved by, after supplying a computer program capable of realizing the functions that has been described above to a network verification device, the CPU 10 reading the computer program into RAM 11 and executing the computer program.

Such supplied computer program may be stored in a readable and writable memory (temporary storage medium) or a computer-readable storage device such as a hard disk device or the like. In such case, the present invention can be understood as being constituted by a storage medium storing such computer program or cords representing such computer program.

### REFERENCE SIGNS LIST

100 Network

101 Virtual network control unit

1021, 1022, 1023 Network device

200, 300, 400 Network verification device

210 Virtual-network-configuration input unit

220 Physical-network-configuration input unit.

230 Path verification analysis unit

240 Reachable-physical-path storage unit

250 Physical and virtual matching unit

251 Virtual endpoint pair generation unit

252 Virtual endpoint pair storage unit

253 connection path matching unit

254 connection matched path storage unit

260 Violation path output unit

270 Packet transmission control unit

410 Physical path acquisition unit

420 Virtual endpoint pair calculation unit

430 Violation detecting unit

What is claimed is:

1. A network verification device, comprising:
a memory storing instructions; and
one or more processors configured to execute the instructions to:
acquire physical path information relating to a pair of physical devices serving as endpoints of a physical path by which a communication packet is transmitted and received in a network to be verified;
calculate, based on configuration information of virtual devices in a virtual network that, by being associated with the network, is virtually set so as to transmit a communication packet using the network, a pair of the virtual devices serving as endpoints of a virtual path set so as to transmit and receive the communication packet in the virtual network; and
detect a setting violation in the network, based on the acquired physical path information and the calculated pair of the virtual devices.

2. The network verification device according to claim 1, wherein
the virtual devices serving as endpoints of the virtual path are associated with the physical devices serving as endpoints of the physical path by which the communication packet is transmitted and received in the network, respectively.

3. The network verification device according to claim 2, wherein,
the one or more processors are further configured to execute the instructions to:
when there is no pair of the virtual devices associating with the pair of the physical devices serving as endpoints of the physical path included in the physical path information, determine that the path formed by the pair of the physical device is a violation.

4. The network verification device according to claim 2, wherein,
the one or more processors are further configured to execute the instructions to:
when there is no pair of the physical devices associating with the calculated pair of the virtual devices in the physical path information, determine that the path of the pair of the virtual devices is a violation.

5. The network verification device according to claim 4 wherein, comprising:
the one or more processors are further configured to execute the instructions to:
perform a control so as to transmit the communication packet, from one of the physical devices associated with one of a pair of the virtual devices forming a path determined as a violation, to another of the physical devices associated with another of the pair of the virtual devices.

6. The network verification device according to claim 5, wherein,
the one or more processors are further configured to execute the instructions to:
when the communication packet is transmitted, acquire the physical path information again, and
detect a setting violation in the network based on the newly acquired physical path information and the calculated pair of the virtual devices.

7. A network verification method, comprising:
acquiring physical path information relating to a pair of physical devices serving as endpoints of a physical path by which a communication packet is transmitted and received in a network to be verified;
calculating, based on configuration information of virtual devices in a virtual network that, by being associated with the network, is virtually set so as to transmit a communication packet using the network, a pair of the virtual devices serving as endpoints of a virtual path set so as to transmit and receive the communication packet in the virtual network; and
detecting a setting violation in the network, based on the acquired physical path information and the calculated pair of the virtual devices.

8. The network verification method according to claim 7, wherein,
when detecting the setting violation, in a case where a pair of the virtual devices to be associated with the pair of the physical devices serving as endpoints of the physical path included in the physical path information does not exist, a path formed by the pair of the physical devices is determined as a violation.

9. The network verification method according to claim 8, wherein,
when detecting the setting violation, in a case where a pair of the physical devices to be associated with the calculated pair of the virtual devices does not exist in the physical path information, a path formed by the pair of the virtual device is determined as a violation.

10. A storage medium storing a program that causes a computer to execute:
a process that acquires physical path information relating to a pair of physical devices serving as endpoints of a physical path by which a communication packet is transmitted and received in a network to be verified;
a process that calculates, based on configuration information of virtual devices in a virtual network that, by being associated with the network, is virtually set so as to transmit a communication packet using the network, a pair of the virtual devices serving as endpoints of a virtual path set so as to transmit and receive the communication packet in the virtual network; and
a process that detects a setting violation in the network, based on the acquired physical path information and the calculated pair of the virtual devices.

11. The network verification device according to claim 3, wherein,
the one or more processors are further configured to execute the instructions to:
when there is no pair of the physical devices associating with the calculated pair of the virtual devices in the physical path information, determine that the path of the pair of the virtual devices is a violation.
